(19) United States
(12) Patent Application Publication
(10) Pub. No.: US 2004/0070208 A1
(43) Pub. Date: Apr. 15, 2004

(54) Mechanical power generating device

(76) Inventor: Chin-Ho Chiu, Taipei Hsien (TW)

Correspondence Address: Chin-Ho Chiu, P.O. Box No. 6-57, Chung-Ho, Taipei, 235, TW

(21) Appl. No.: 10/270,279

(22) Filed: Oct. 15, 2002

(51) Int. Cl. H02P 9/04

(52) U.S. Cl. 290/1 R

(57) ABSTRACT

A mechanical power generating device mainly has a stand disposed with a bull gear meshing with respectively a ratchet and a pinion on two sides thereof. The ratchet pivotally connects with a connecting link for connecting two u-shaped swing links; two ends of the swing link are respectively disposed with heavy blocks. The area adjacent to the center of the stand is respectively disposed with a sliding block and a rack; when the swing link swings, the heavy block presses the sliding block downwardly to relatively make the rack drive a driven gear to cause an electric generator to produce power. Furthermore, the swing link swings to rotate the bull gear for driving another swing link thereby achieving the objective of generating mechanical power.

### BACKGROUND OF THE INVENTION

1) Field of the Invention

The present invention relates to a mechanical power generating device, more particularly to a device utilizing continuous swings to generate mechanical power.

2) Description of the Prior Art

Accordingly, the ongoing consumption of the earth energy and the delay of developing substitute energy have caused the human beings to face energy crisis recently. Therefore, the structure of consistent power which had been discussed extensively in the 19^{th} century becomes an important topic again. However, no any satisfactory breakthrough has been reached so far. As for the time being, the power is still generated through natural methods, such as the use of windmill, solar energy and hydraulic power. To develop new power energy is really an urgent issue.

### SUMMARY OF THE INVENTION

Therefore, the primary objective of the present invention is to provide a mechanical power generating device utilizing an inertial swing to generate mechanical power thereby solving the energy problems.

The present invention mainly comprises a triangular stand disposed with a bull gear meshing respectively with a ratchet and a pinion on two sides thereof. The ratchet pivotally connects with a connecting link for connecting two u-shaped swing links; two ends of the swing link are respectively disposed with heavy blocks. The area adjacent to the center of the stand is respectively disposed with a sliding block; the bottom rim of the sliding block is disposed with a rack; when the swing link swings, the heavy block presses the sliding block downwardly to relatively make the rack drive a driven gear to cause an electric generator to produce power. Furthermore, the swing link swings to rotate the bull gear for driving another swing link thereby achieving the objective of generating mechanical power.

In said mechanical power generating device, the rack drives the driven gear to connect with the electric generator via a belt; therefore, the rack drives the driven gear to relatively drive the electric generator to produce power energy.

To enable a further understanding of the main features and the innovation of the present invention, the brief description of the drawings below is followed by the detailed description of the preferred embodiment.

### BRIEF DESCRIPTION OF THE DRAWINGS

FIG. 1 is a pictorial and schematic drawing of the present invention.

FIG. 2 is a schematic drawing of a lateral view of the present invention.

FIG. 3 is a schematic drawing of a sliding block structure of the present invention.

FIG. 4 is a schematic drawing of an exemplary embodiment of the movement of the present invention.

FIG. 5 is a schematic drawing of an exemplary embodiment of the movement of the present invention.

FIG. 6 is a schematic drawing of an exemplary embodiment of the movement of the present invention.

### DETAILED DESCRIPTION OF THE PREFERRED EMBODIMENTS

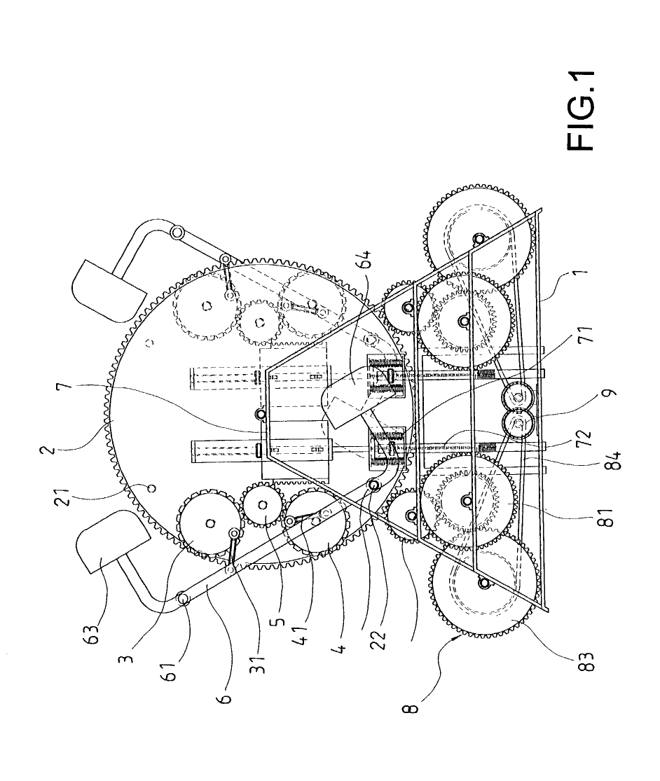

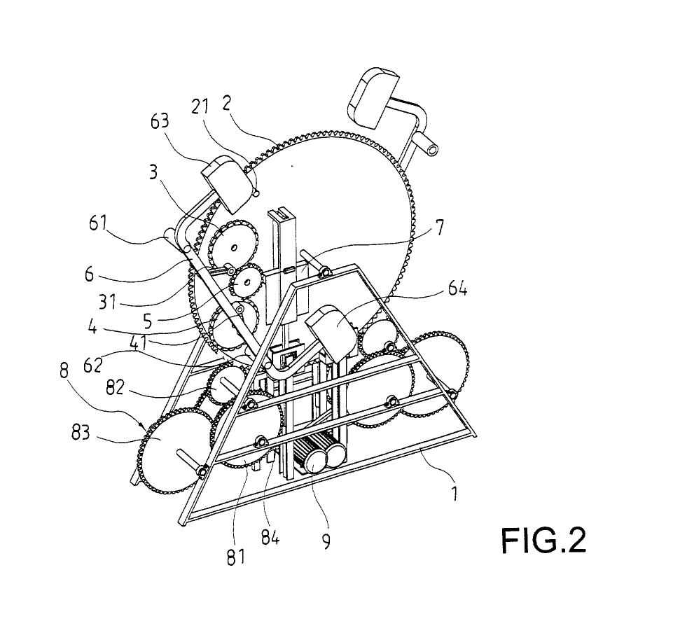

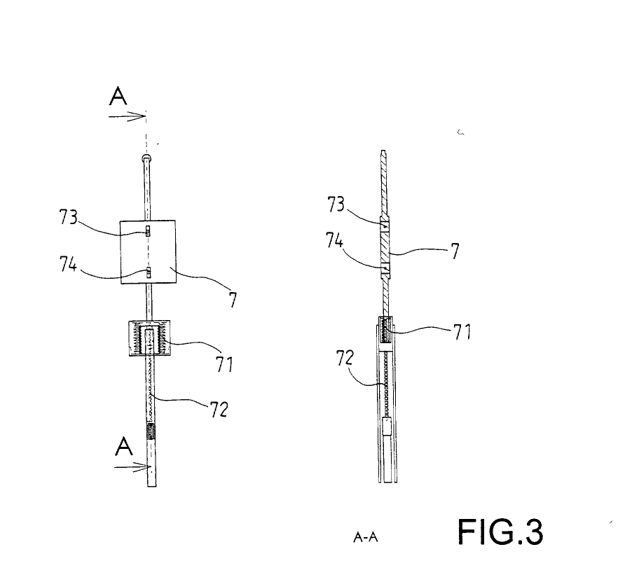

FIGS. 1, 2 and 3, show the pictorial, schematic and lateral view drawings of the present invention as well as the schematic drawing of the sliding block structure. The present invention mainly comprises a triangular stand (1) with a bull gear (2) disposed at the center on the top rim thereof; two sides of the bull gear (2) are respectively disposed with ratchets (3, 4) and a pinion (5); wherein, the ratchets (3, 4) pivotally connects with connecting links (31, 41) which further connect with u-shaped swing link (6); upper and lower aspects of the swing link (6) are respectively disposed with protruding posts (61, 62); two ends of the swing link (6) are respectively disposed with heavy blocks (63, 64).

The upper and lower aspects of the ratchets (3, 4) of the bull gear (2) are respectively disposed with supporting points (21, 22) composed by electronic elements for sucking or releasing the protruding posts (61, 62) of the swing link (6); a sliding block (7) is respectively disposed in the area adjacent to the center of the stand (1). The sliding block (7) is disposed with a spring (71), a rack (72) and positioning devices (73, 74); the rack (72) meshes with a driven gear (81) and two other driven gears (82, 83) thereby forming a driven gear set (8); the gear (83) connects with an electric generator (9) via a belt (84).

According to the assembly of the abovementioned members, when one of the swing links (6) swings inwardly, the ratchet (4) rotates to relatively turn the bull gear (2); the swing link (6) uses the heavy block (63) to press the sliding block (7) downwardly such that the rack (72) drives the driven gear (81) thereby driving the electric generator (9) to produce power energy. The bull gear (2) turns to make another swing link (6) move the same way thereby driving another electric generator (9) to produce power energy. The repetitive and recycling movement achieves the objective of generating mechanical power.

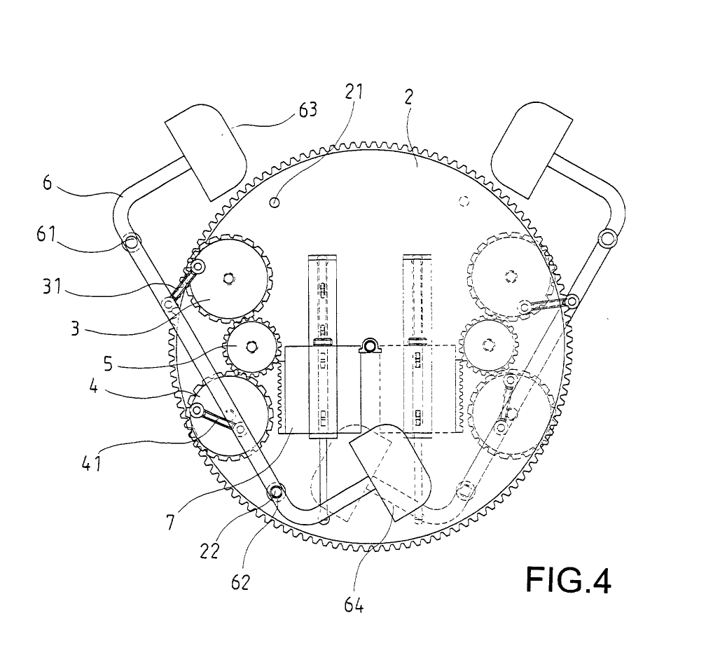

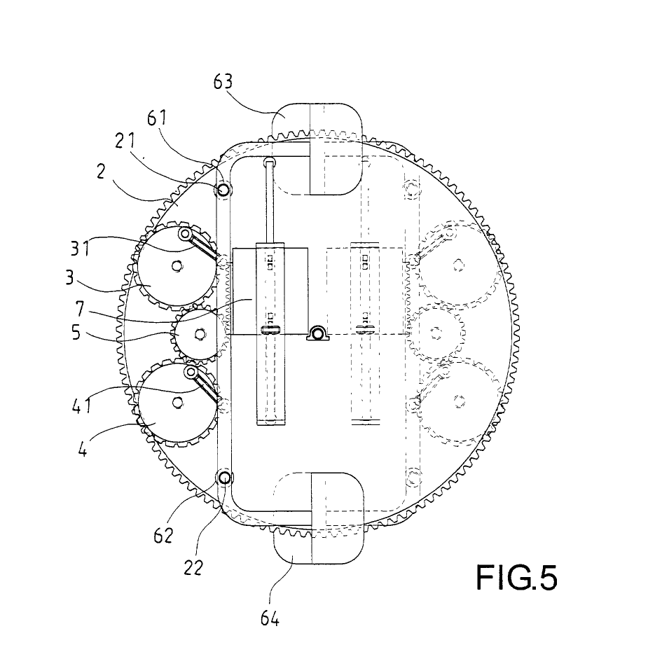

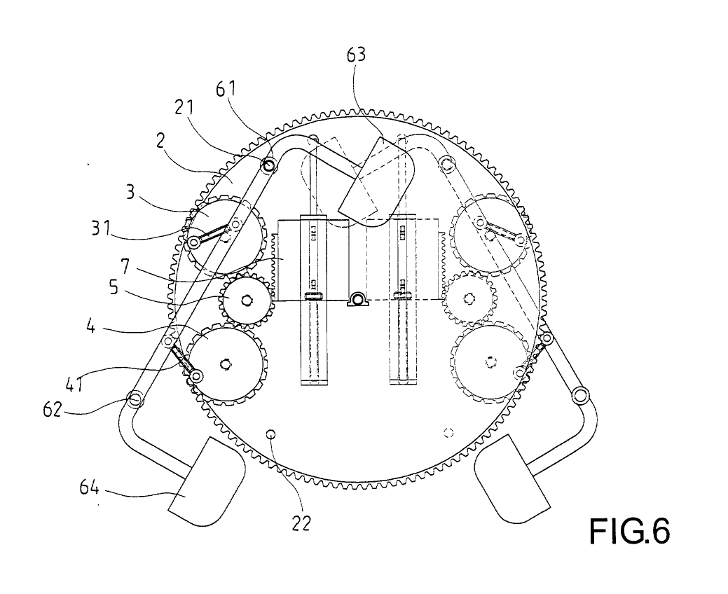

FIGS. 4, 5 and 6 show the schematic drawings of the exemplary embodiment of the movement of the present invention. When in moving, one of the swing links (6) swings first to press the sliding block downwardly (7) thereby making the electric generator (9) produce the power energy. After starting to swing, the supporting point (21) locks and positions the protruding post (61) of the swing link (6) into a slant state. Therefore, the bull gear (2) starts to rotate and make another swing link (6) move the same way thereby causing another electric generator (9) to produce power energy and the bull gear (2) to rotate reversely; after rotate reversely, the supporting point (21) releases the protruding post (61); furthermore, the other supporting point (22) locks and positions the protruding post (62) for another swinging movement. Therefore, mechanical power is generated through the reciprocating and recycling movement.

In summation of the abovementioned, the present invention utilizing the bull gear disposed with a ratchet to cooperate with the swing link disposed with heavy blocks to generate mechanical power is of a practical design and innovative invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A mechanical power generating device comprises:
a stand in a triangular shape;
a bull gear disposed at the central position on the top rim of the stand; two sides thereof respectively mesh with a ratchet and a pinion; the upper and lower aspects of the ratchets are respectively disposed with positioning supporting points;
two swing links in u-shapes; the upper and lower aspects thereof respectively are connected by connecting links at eccentric positions; two ends thereof are respectively disposed with heavy blocks; protruding posts are respectively disposed at positions adjacent to the bent areas;
two sliding blocks are respectively disposed at the positions adjacent to the central area of the stand; the lower aspect thereof is disposed with a spring; a rack is disposed at the lower aspect of the spring;
a driven gear set is disposed at the lower aspect of the stand for meshing with the rack and connects with an electric generator via a belt;
by virtue of the assembly of the abovementioned members, the swing link swings to press the sliding block downwardly to make the rack drive the driven gear thereby causing the electric generator to produce power energy; furthermore, the rotation of the bull gear makes the two swing links alternatively swing to generate mechanical power.
